(19) United States
(12) Patent Application Publication
(10) Pub. No.: US 2005/0021318 A1
(43) Pub. Date: Jan. 27, 2005

(54) Shape generation apparatus, control method to cause computer apparatus to operate as shape generation apparatus and computer executable program to allow computer apparatus to execute the control method

(76) Inventors: Keisuke Inoue, Sagamihara-shi (JP); Doi Jun, Yokohama-shi (JP); Atsushi Yamada, Yokohama-shi (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/819,272

(22) Filed: Apr. 7, 2004

(30) Foreign Application Priority Data
Jun. 10, 2003 (JP) 2003-165609

(51) Int. Cl. G06F 17/10

(52) U.S. Cl. 703/2

(57) ABSTRACT

[Object] To provide a shape generation apparatus, a control method to cause a computer apparatus to operate as a shape generation apparatus and computer executable programs to allow a computer apparatus to execute the control method.

[Solution] The shape generation apparatus of this invention has an input model storage part 20 to store 3-dimensional input model data, an adjacency graph storage part 22 to store adjacency graph data generated by assigning face clusters to the input model, and a cluster coupling part 28 which executes coupling processing for the face clusters of the adjacency graph data. In addition, the shape generation apparatus also has a topology judgment part 30, which reads out the adjacency graph data and judges topology of the adjacency graph data read out, and a topology operation part 34, which changes node or arc data of the adjacency graph data in response to the judgment of the topology judgment part.

### DETAILED DESCRIPTION OF THE INVENTION

1. Field of the Invention

This invention relates to generating a recognition model from an inputted 3-dimensional shape, and more particularly to a shape generation apparatus, a control method to allow a computer apparatus to operate as a shape generation apparatus and computer executable programs to cause a computer apparatus to execute the control method, which can smoothly generate a recognition model by guaranteeing topology consistency of cluster data in the case that cluster data is generated from an input model of a 3-dimensional shape and then a recognition model is formed.

2. Background Art

As one of hexahedral mesh generation methods, which target finite element analysis, there is a method using approximation solids, which is called as a recognition model. The recognition model is a solid defined in the integer coordinates space called as ijk space. This recognition model is constituted of planes that are perpendicular to either of three axes, and a model that approximates a solid by accumulating unit cubes. The surface topology of the unit cube is constituted of 2-dimensional manifolds. Once, if a recognition model that geometrically approximates an original solid is generated, the recognition model can easily be transformed into a structured mesh constituted of elements of unit cube. Boundary planes of the acquired structured mesh are mapped onto the surfaces of the original solid and smoothing is performed on it to acquire a hexahedral structured mesh corresponding to the original solid.

Hereafter, the outline of a conventional method to generate a recognition model will be explained. For example, as a method to generate a recognition model, a method to divide the surfaces of a 3-dimensional shape into clusters. In this case, inputted values are mesh data that expresses the surfaces of a solid as a group of 2-dimensional (2D) elements (triangles or quadrangles). The inputted 2D elements are gradually gathered into a unit referred as a cluster considering an angle with an axis of coordinates, a dihedral angle with an adjacency element and a shape of an area (the planarity). Each cluster is assigned with either of three directions of i, j and k, which are directions of a Cartesian coordinates system and a positive/negative value corresponding to each direction. If a state in which all elements belong to either of three kinds of clusters is finally acquired, each cluster is considered to be a surface of the recognition model, and topology construction of the recognition model is completed.

After clustering, an optimization problem, the parameters of which are the number of division of each edge in the recognition model (corresponds to the length), is set up, and then the integer programming problem is solved to geometrically determine a structured mesh of the recognition model. A structured mesh generation apparatus using a conventional clustering method generally includes the following functions:
(1) shape input part: input a shape, which is a target object to be generated its mesh;
(2) cluster generation part: classify the surfaces by clustering and generate a recognition model
(3)• recognition model geometry determination part: for the recognition model determined with topology, determine the number of division of each edge; and
(4) mesh generation part: generate a structured mesh and transform it so as to satisfy the inputted shape. If necessary, modify the mesh.

The problem of the above-described conventional clustering method is that it is not guaranteed to generate a recognition model provided with topological consistency after completion of cluster construction. For example, if a shape, such as a quadrilateral pyramid, is intuitively clustered, a plane does not exist at the apex, so that an independent surface cluster cannot be assigned and clusters of the bottom and its corresponding upper surface are not generated. Such a clustering provides a recognition model without shape consistency, which cannot regenerate an input model. Therefore, appropriate data cannot be provided to mesh generating processing at the next stage, or if a mesh can be generated, it is recognized as a completely different 3-dimensional shape.

In the view of vertex of a recognition model, structures, which are allowed as cluster directions surrounding a vertex, are restricted to at most several combinations. Therefore, in determination of cluster directions (i, j, k) (hereafter, refer to them as “color” in this invention), if a vertex that is contrary to a restriction occurs, its portion may be processed later. However, such a method cannot solve the problem of a quadrilateral pyramid.

In addition, if seemingly consistent clustering is achieved, a solution may not exist at the stage of assigning the number of division (positive integer) to each edge. The cause is that clustering itself gives inconsistency that is inappropriate for automatic shape recognition by a computer apparatus. FIG. 24 shows a failure example of generating consistent recognition model in a conventional method. In an input model shown in FIG. 24, after going round on the input model, a plane to be recognized that it exists at a high position smoothly connects to a plane to be recognized that it exists at a low position. In this case, even if the length in an axis direction is pre-defined to recognize plane height, inconsistency in length in an axis direction occurs and mesh generation is failed.

[Problems to Be Solved by the Invention]

In conventional clustering of an input model, there remain the following problems:
(i) determine whether or not topology inconsistency in clustering (includes clustering during processing) exists;
(ii) specify where a cause exists in clustering if topology inconsistency exists; and
(iii) automatically execute correction processing to secure topology consistency for a specified part.

In the above-described problems, only topological consistency is extracted, but to provide a correct recognition model, not only topology consistency but also the degree of geometrical approximation are important. However, without topology consistency, geometrical accuracy cannot be provided. In this invention, if topology consistency is satisfied and clusterings associated with an original clustering can be listed as many as possible, in the case that a geometrically correct recognition model is selected after that, efficient selection can be performed.

### SUMMARY OF THE INVENTION

In this invention, a shape generation apparatus is constituted of a cluster coupling part, a topology judgment part, which judges topological consistency, and a topology operation part to receive output from the topology judgment part and to provide an appropriate topology to a cluster. The topology judgment part examines and judges the topology of cluster data during or after clustering to judge the consistency of cluster data. Subsequently, the topology judgment part transmits the judgment result of consistency, labels of the judged clusters and inconsistency data to consistency to the topology operation part.

The shape generation apparatus of this invention includes topology information to judge topology consistency. The topology operation part refers to the topology information that includes topology change rules to change the topology of cluster data, analyzes inconsistency data, and judges the contents of inconsistency. In addition, the topology operation part selects topology conditions to be allowed in response to the judgment, changes the topology of cluster data, and returns the cluster data that its topology consistency is allowed to a cluster generation part.

By adopting the structure of this invention, for input shapes that cannot correctly be processed with conventional clustering methods, 3-dimensional shapes that their structure meshs can finally be generated, can be provided.

Therefore, according to this invention, a shape generation apparatus for 3-dimensional objects using a computer apparatus, including:
an input model storage part to store 3-dimensioanl input model data;
an adjacency graph storage part to sore adjacency graph data generated by assigning surface clusters to the input model data;
a cluster coupling part which executes coupling processing of surface clusters of the adjacency graph data;
a topology judgment part which reads out the adjacency graph data and judges topology of the read adjacency graph data; and a topology operation part which responds to judgment of the topology judgment part and changes node data or arc data of adjacency graph data, is provided.

The topology judgment part of this invention reads out the adjacency graph data and judges topology of arcs and nodes of the adjacency graph data. In response to the judgment, the topology judgment part allows the topology operation part to acquire corresponding adjacency graph data.

The topology judgment part of this invention includes direction identification data, which identifies an arc that crosses from a specified node of the adjacency graph data to another node and indicates the crossing direction of the arc, and an axis direction graph data generation part, which generates axis direction graph data that corresponds the specified node to the other. The shape generation apparatus includes an axis direction graph storage part to store generated axis direction graph data.

The topology judgment part of this invention reads out axis direction graph data from the axis direction graph storage part and judges the existence of cycle or loop between the nodes using the direction identification data. In response to the judgment, the topology judgment part allows the topology operation part to acquire corresponding adjacency graph data.

The topology operation part of this invention changes node or arc data of the acquired adjacency graph data with reference to a topology table, and updates data in the adjacency graph data storage part using the changed adjacency graph data.

The cluster coupling part of this invention judges update of the adjacency graph data and acquires the updated adjacency graph data.

In addition, according to this invention, a control method to control a computer apparatus as a shape generation apparatus for 3-dimensional objects, allows the computer apparatus to execute:
a step of storing 3-dimensional input model data into an input model storage part;
a step of storing adjacency graph data, which is generated by assigning surface clusters to the input model data, into an adjacency graph data storage part;
a step of allowing a cluster coupling part to read the adjacency graph data, perform coupling processing of surface clusters, and store the processing result into memory;
a step of allowing a topology judgment part to read out adjacency graph data stored in the memory and judge the topology of adjacency graph data; and
a step of allowing a topology operation part to read adjacency graph data in response to judgment of the topology judgment part.

In this invention, the control method allows the computer apparatus to execute:
a step of allowing the topology judgment part to read out the adjacency graph data and judge the topology of arc and node of the adjacency graph data; and
a step of allowing the topology operation part to acquire corresponding adjacency graph data in response to the judgment.

The topology judgment part of this invention includes an axis direction graph data generation part, and the control method allows the axis direction graph data generation part to execute:
a step of identifying an arc that crosses from a specified node of the adjacency graph data to another one and calculating direction identification data to indicate crossing direction of the arc; and
a step of generating axis direction graph data, which is associated with the direction identification data, the specified node and the other, and registered, and allowing the axis direction graph storage part to store the generated graph data.

In this invention, the control method allows the topology judgment part to execute:
a step of reading out axis direction graph data from the axis direction graph storage part and judging the existence of cycle or loop between the nodes using the direction identification data; and
a step of allowing the topology operation part to acquire corresponding adjacency graph data in response to the judgment.

In this invention, the control method allows the topology operation part to execute: a step of changing node or arc data of the acquired adjacency graph data based on topology information to change adjacency graph data; and
a step of updating data in the adjacency graph data storage part using the changed adjacency graph data.

In this invention, the control method allows the cluster coupling part to execute:
a step of judging update of the adjacency graph data and acquiring the updated adjacency graph data.

Furthermore, according to this invention, computer executable programs, which allow a computer apparatus to execute the above-described control methods, are provided.

[Preferred Embodiment]

Hereafter, this invention will be explained in detail with preferred embodiment shown in the drawings, however, this invention is not restricted to the preferred embodiment shown in the drawings.

A. Clustering Expression By Adjacency Graph

Hereafter, terms to be used as common concepts in this invention and clustering expression method will be explained.

In this invention, while clustering is made to go on from the first state that only unclassified elements (triangle and quadrilateral) exist to the state that clustering is completed, clustering is consistently expressed using adjacency graph. Adjacency graph to be used in this invention is a graph, in which faces of a polyhedron are transposed to vertices and then adjacency of faces are transposed to edges connecting vertices corresponding to the faces. In addition, in adjacency graph of this invention, term “node” indicates cluster in a real model, and term “arc” indicates adjacency relation between clusters (that is, whether or not edges are shared).

In this invention, for adjacency graph, terms “node”, “arc” and “face (polygon or n-gon) are always used, and in the case of referring to a real model, “vertex”, “edge” and “cluster” are used. In the state before beginning clustering, each element is considered to be one cluster (or at first, elements are gathered up to some extent and glanularity is set to be coarse). FIG. 1 shows one part of clusters (a) used in this invention and corresponding adjacency graphs (b). In FIG. 1, (a) and (b) are in a pair relation. A sequence of arcs around a node shows a sequence of edges between adjacency elements in an original shape model.

Nodes and arcs in adjacency graphs have attribute values that reflect corresponding clusters and edges in a real model, respectively. These attribute values are shown collectively below:

(I) Node Attribute (Cluster Attribute)

∘□□ Direction (color): I, j, k and unknown. In the case of i, j and k, directions are branched into plus and minus ones, so that there are totally seven kinds of directions.
   (II) Arc Attribute (Attribute of Edge Between Clusters)
∘□□ Edge direction: i, j, k and unknown. “unknown” means that one of directions of nodes at both ends is unknown, or nodes at both ends have the same color and different signs. For example, it is shown with (j+, unknown) or (j+, j−).
   (III) Concave and Convex of Edge (Concave, Convex and Unknown)
∘□□ Arc having unknown direction is always “unknown”. In the other case, as will be described later, it is determined by geometry calculation (scalar triple product)

The above-described concave and convex of an edge are determined corresponding to an angle in a recognition model. FIG. 2 shows the outline of a method to determine the concave and convex of a shape that is constituted of surface clusters f, and f₂, and edge L. To discriminate concave and convex in adjacency graphs used in this invention, the sign of the above-described scalar triple product (n×m)·a is used. Specifically, if scalar triple product is positive, the edge is convex, if negative, it is concave. In addition, in this invention, if the absolute value of a triple product is a constant threshold or less, the edge is “unknown.” Vectors n and m are axis direction unit vectors to be determined from clusters (e.g., (0, −1, 0)). In addition, the vector a is the direction vector of an edge, the direction of which is counterclockwise looking the cluster of n from the front, and is determined from geometrical properties of actual clusters. If concave and convex of edges are determined, the size relation of both ends related to the direction (i, j and k directions) of each edge can be logically determined from combinations of (n, m) and concave and convex of edges. The concave and convex relation achieved from the shape shown in FIG. 2 is shown in FIG. 3. The size relation shown in FIG. 3 will be used in topology judgment to be described in detail later.

In an algorithm of a cluster method, at first, directions (i+, i−, j+, j−, k+, k−) for several clusters, which have clear normal directions, are determined. Subsequently, clusters, the directions of which are not determined, are merged to adjacency clusters from the appropriate one, and then “color” is assigned to them.

In adjacency graphs, it is not permitted that the same kinds of nodes are adjoined through arcs except the case of nodes of “unknown.” When this state occurs, arcs are immediately degenerated and nodes at both ends are unified so as to be one.

The unified node indicates the merged area of the clusters indicated by the two original nodes, and the direction is the original one.

B. Consistency Conditions on Adjacency Graphs

In this invention, the consistency judgment of a recognition model is performed with a sequential processings on adjacency graphs using adjacency graphs and derived “axis direction graphs.” In consistency judgment, local conditions, which are ones for processing consistency between nodes or arcs, and global conditions, which are ones for processing sequential consistency between nodes are used. The local and global conditions can be defined as follows.

(a) Local Conditions

(a-1) conditions for every face of adjacency graphs (patterns permitted around a vertex of a cluster).
(a-2) conditions for every node of adjacency graphs (restriction for edges, which are the outline of a cluster).
   (b) Global Conditions
Conditions for a cycle or a loop in an axis direction graph (possibility to assign the number of division to an edge). A specific embodiment for each of the above-described conditions will be described in detail later.
   C. Processing for the Shape Generation Method of This Invention

FIG. 4 shows a rough flowchart of processing of the shape generation method of this invention. The processing shown in FIG. 4 starts from step S10, generates initial clusters at step S12, and stores index values of cluster edges into appropriate memory at step S14. The index value of a cluster edge indicates the priority of cluster merge for a pair of adjacency clusters represented by the edge, and calculated from the angle of representative normal vectors of both clusters or the shape of a coupled cluster (the planarity). At step S16, cluster edges are sorted in the order of index values and stored into appropriate memory. At step S18, data is read out from memory in decreasing order of index value, and at step S20, it is determined whether or not there exists a read cluster edge. At step 20, if there is an edge (yes), it is determined whether or not the edge can be coupled at step S22.

If it is determined that the edge can be coupled at step S22 (yes), at step S24, edge data between position coordinates of ends of corresponding edge is deleted, and data of new merge cluster is generated to couple cluster. Then, data of the coupled cluster is registered in memory. At step S28, topology examination and operation processing is executed and topology consistency is changed.

On the other hand, at step S20, if it is determined that there is not an edge (no), the processing progresses to step S26 and at step S26, colors of clusters, the colors of which have not been determined and can be determined, are determined. In addition, at step S22, if it is determined that coupling is impossible (no), the processing is returned to step S18 and next cluster edge is read out to repeat processing. At step S30, it is determined whether or not all of the clusters registered in memory are processed based on existence of clusters, the colors of which are “unknown”. At step S30, if clustering is determined to be completed (yes), the processing progresses to step S32 and the processing of this invention is completed. On the other hand, at step S30, if clustering is not completed (no), the processing is returned to step S14 and data is updated reflecting the data of coupled clusters generated through steps from S14 to S28. Subsequently, processing of steps from S16 to S30 is repeated again.

FIG. 5 restrictively shows conditions for determining the local conditions at step S28 in the shape generation method of this invention using a real model. As determination criteria of topology consistency at step S28, direction of normal vectors, in Cartesian coordinates system, and concave and convex of surface of three surfaces, which forms a shape surrounding a specified vertex V, can be used. In specific processing, surface direction, which is calculated in accordance with the method shown in FIG. 2, and data of concave and convex are used.

As shown in FIG. 5, all kinds of surfaces, which surround a specified vertex V to form a cube, are limited to six kinds.

If surfaces surround a specified vertex V to form a cube in a relation rather than this, a recognition model permitted topologically cannot be formed. In examination of topology consistency in this invention, surface data as shown in FIG. 3 is used and data of three surfaces that constitute a specified vertex is judged. As a result of the judgment, clusters that do not have topological relations shown in FIG. 5 are removed and clusters permitted topologically are remained.

Furthermore, the topology examination and operation processing at step S28 in this invention will be explained in detail. FIG. 6 shows a detailed flowchart of the topology examination and operation processing in this invention. In the topology examination and operation processing shown in FIG. 6, at step S40, the data of updated adjacency graphs is read out from memory and stored in a buffer memory, in which it is held during processing. At step S42, the above-described local condition (a-1) are judged, and if the local condition (a-1) are satisfied (yes), the processing progresses to step S44. Furthermore, the local condition (a-2) are judged.

At step S42, if the local condition (a-1) are not satisfied (no), the processing progresses to step S46 and topology operations 1 or 2 as will be described later are executed for clusters that are processed at this point. Then, the processing is returned to the judgment at step S42. In addition, at step S44, if the local condition (a-2) are not satisfied (no), the processing progresses to step S48 and topology operations 3 as will be described later are executed for clusters that are processed at this point. Then, the processing is returned to step S42, and the processing is repeated until the local conditions are satisfied.

If the local conditions are satisfied for specified clusters, the topology examination and operation processing shown in FIG. 6 progresses to step S50 and the modification results are reflected to axis direction graph data. After data update is executed, the processing progresses to step S52, updated data is read and global conditions as will be described in detail are calculated to judge whether or not the global conditions are satisfied. In the judgment at step S52, if the global conditions are not satisfied (no), the processing as will be described later is applied and clusters are divided at step S54. Subsequently, the processing is returned to step S50, and axis direction graph data is updated in accordance with the division result to be registered. At step S52, if the global conditions are satisfied (yes), the processing progresses to step S30 in FIG. 5 and processing for a specified cluster is continued until topology consistency is locally and globally guaranteed.

D. Details of Judgment Processing of Topology Consistency

D-1<Locally Consistency Conditions: Topology Information>

The judgment of the conditions for every adjacency graph surface (a-1) is executed using data, in which the row of clusters around a vertex listed in FIG. 3 is replaced into patterns in adjacency graph. The outline of this processing is shown in FIG. 7. FIGS. 7(a) to (c) show a real model and FIGS. 7(d) to (f) show data replaced into patterns in adjacency graph. Specifically, in the transformation from FIG. 7(a) to FIG. 7(d), points included in a specified surface are extracted and generated so as to satisfy with a pair relation, and theses points are connected and formed so as to include a vertex V.

In the case of the adjacency graph shown with a triangle in FIG. 7(d), the real model data in FIG. 7(a) is converted into that that is shown with (P1, P2, P3). As shown in FIG. 7, the vertex V (a point, in which three or more clusters contact) in a real model is transformed into surfaces F_{1 to F}₃ in adjacency graphs in a pair relation. In FIG. 7, surface colors (i, j and k) in a real model are expressed with three kinds of hatchings (in this invention, if “color” of surface is referred as only i, both i+ and i−are included).

In addition, for patterns of one adjacency graph, if there are a plurality of nodes that have the same color, the nodes can be attached with a label, such as “1” or “2”, to mutually distinguish marks of nodes. As shown in FIG. 3, in the attribute of arcs that constitute a polygon, if a real model is considered to be as accumulation of cubes, topological restrictions occur for concave and convex of edges. If adjacency graphs are triangles, all combinations of concave and convex are permitted. However, if they are a quadrilateral and a hexagon, FIG. 3 shows that concave and convex must appear by turns. The judgment of the condition (a-1) of this invention is performed in a surface unit of adjacency graph shown in FIGS. 7(d) to (f). When nodes, the colors of which are not determined, do not exist on the boundary of each surface, evaluation is executed.

In addition, the condition (a-2) for every node of adjacency graph correspond to ones for every cluster in a real model, so that the conditions can be put another way as will be described below:
(i) Arcs connected to a node correspond to cluster edges of two colors among i, j and k (one color and three ones are impossible)
(ii) Arcs (cluster edges) are two or more for each color.

That is, there are four or more arcs (the degree of node is four or more).

In the above-described judgment, as long as nodes, the colors of which are not determined, are not listed in the judge, the judgment of the local condition (a-1) and (a-2) is impossible, so that parts, which do not satisfy with the local conditions topologically, can easily be specified from a pair relation of adjacency graphs. A Part, which does not more specifically satisfy with the local conditions, can be specified as a vertex in a real model for the local condition (a-1) and as a surface for the local condition (a-2).

In addition, among patterns of adjacency graphs (the local condition (a-1)) shown in FIGS. 7(d) to (f), arcs, such as (i+, i−), which connect nodes that have the same color and different signs, do not exist. Thereby, arcs that connect nodes having different signs, can be removed before all colors of nodes, which share a surface boundary in adjacency graph, are determined.

D-2<Sufficiency Method of the Local Conditions>

If local consistency conditions are not satisfied during or after clustering, adjacency graphs that satisfy with local consistency conditions can be generated by sequentially applying the following operations. However, in the correction process to be explained below, colors of related nodes are assumed not to be “unknown.” If “unknown”, the processing can progress by not adding corresponding elements into a judgment list before the colors are determined.

FIG. 8 shows the outline of processing of topology operations 1 to 3 to be explained below. In addition, in FIG. 8, a figure of each topology operation on adjacency graph and a typical embodiment of changing of real clustering corresponding to the figure are shown.

As shown in FIG. 8(a), in the topology operation 1, arcs that connect nodes having the same color and different signs are degenerated into edges (clusters, which turn to an opposite direction, contact) corresponding to the arcs, and then a pair of data in the degenerated edges is removed. Thereby, polygons, which are quadrilateral or more, occur from two triangles. In the lower side of FIG. 8(a), the change of a real model related to the processing performed for adjacency graph is shown.

In addition, the topology operation 2 is constituted of two operations a and b. The topology operation 2a supplies polygons of adjacency graph, and processes polygons that do not satisfy with patterns in FIG. 7. A polygon face Fc in adjacency graph shows the apex of a cone topologically. Therefore, in a real model, it is solved by either of that a vertex is extended so as to be an edge or a new cluster is inserted. In a specified embodiment of this invention, as shown in FIG. 8(b), this processing can be executed by inserting a new node (a new cluster). In the loop of an n-gon (n≧4), it is assumed that nodes of two colors appear by turns. In this case, the conditions in FIG. 3 are not satisfied even if either of the two colors is inserted, so that the node of one remaining color is newly inserted to generate an adjacency graph as triangles of n pieces. In this case, nodes of two colors appear by turns, so that n becomes even. The sign of a new node is not judged in this processing, and can be determined without inconsistency by geometrically transforming into a real model. The change of clustering of a real model corresponding to this operation is shown in the lower side of FIG. 8(b).

In addition, the topology operation 2b to be applied in the same way is an operation, in which a diagonal arc is generated into an adjacency graph. This is shown in FIG. 8(c). The combination, in which nodes can become both ends of a diagonal, in the case of n-gon, is at most (nC₂-n) ways, e.g., quadrangle: two ways; pentagon: five ways; and hexagon: nine ways. Each of the cases corresponds to either of the followings, so that each operation to update data of adjacency graph is performed.

2b (i): In the case of that both ends of a diagonal are different kinds (different two among i, j and k), two polygons that use a diagonal arc are generated. If triangles are generated, the condition (a-1) are surely satisfied. If quadrangle or more, it is determined whether or not the condition (a-1) are satisfied using the above-described method. If not satisfied, for the generated polygons, processing of the above-described topology operation 2(b) is applied again (FIG. 8(c) (i)).

2b (ii): If both ends of a diagonal have the same color and different signs, a diagonal arc is not added into the combination (FIG. 8(c) (ii)), so that other possible processing is performed.

2b (iii): In addition, if both ends of a diagonal have the same color and the same sign, degeneration is immediately produced between diagonals by inserting a diagonal arc. After merging, polygons (triangle or more) or arcs are generated by two in total. In this case, as long as that arcs are generated, the degree is decreased by one for a node in the opposite side of the arc (FIG. 8(c) (iii)).

In addition, for adjacency graph, for which the degree problem of a node (the local condition (ii)) is judged, the topology operation 1 is performed in advance, so that the node and that that has the same color do not adjoin. Thereby, it is specified that colors of nodes, which adjoin each other, are one or two. Specifically, processing of the degree of a node in the local conditions is performed as will be explained below. FIG. 9 shows the outline of a processing procedure of the topology operation 3 using a real model. FIG. 9(a) is an embodiment in the case of one color, and FIG. 9(b) is an embodiment in the case that colors of adjacency nodes are two, but there is only one adjacency node for one color.

<Change of Node Color>

If the color of an adjacency node is one, its own color and sign are made to match with that of the adjacency node. Immediately, arc degeneration occurs, inconsistency is removed.

<Splitting of Adjacency Node>

The state in FIG. 9(b), in which colors of adjacency nodes are two but adjacency node of at least one color is only one, is can clearly be determined that the cluster expressed by the one adjacency node becomes too big. Therefore, the color of the cluster is returned to “unknown”, and the cluster is splitted into plurality (three or more) to be updated. Then, clustering processing is performed again.

In this invention, adjacency graph data of clustering that satisfies with the above-described local consistency conditions is stored in memory, and each adjacency graph data is read out. Subsequently, cluster boundary is geometrically determined in a real model using a pair relation, and finally, an appropriate solution is selected among them to determine a recognition model, so that the recognition model in accordance with local conditions can be provided.

E. Global Consistency Conditions

With the above-described method, clustering that satisfies with local conditions can be acquired. However, it is presumed that a problem, in which the consistent number of divisions is not assigned to an edge as a recognition model, remains. FIG. 10 shows a real model example including the above-described global topology inconsistency. For topology inconsistency shown in FIG. 10, existence of such inconsistency, where it exists and how to correct it must be judged in a topology consistency examination. This problem may exist even in the state that the above-described local topology consistency is satisfied, so that this is referred to as a global inconsistency.

FIG. 11 shows an embodiment in the case of an inconvenient example that occurs in a real model with global inconsistency. Paying attention to the z axis direction, for parameters zₐ, z_{b}, z_{c} and z_{d} indicating the length of each edge (the number of division), considering zₐ and z_{d} are under topologically equivalent conditions, the following formulas hold.

[Expression 1]
zₐ+z_{b}+z_{c}=z_{d}
zₐ=z_{d} (1)

From the above formula (1), z_{b}+z_{c}=0 is introduced. On the other hand, it is assumed that parameters are positive integers, so that a solution that satisfies restrictions of the above formula (1) does not exist.

For example, in a method using integer programming, division processing that satisfies the above-described restrictions is simultaneously performed with minimizing of a target function, such as the following formula (2). In the following formula (2), the capital letter indicates the number of ideal division for each edge, which is determined from an original shape model.

[Expression 2]
minimized (|zₐ-Zₐ|+|z_{b}-Z_{b}|+|z_{c}-Z_{c}|+|z_{d}-Z_{d}|) (2)
Despite using or not using integer programming, solving problems that include inconsistency is a waste of calculation cost. Furthermore, at the stage, in which it is clear that the problems cannot be solved, specifying a cluster part that causes inconsistency is not easy.

Therefore, in this invention, the existence of inconsistency in restrictions of parameters (the number of edge division) is judged by generating “axis direction graph” from adjacency graph. FIG. 12 shows an embodiment of axis direction graph for the k direction (vertical direction) of the recognition model shown in FIG. 11. The nodes are clusters in the k direction, and arcs with direction indicate a vertical relation in the k direction. The vertical direction can be generated using “direction”, which is one attribute of arc of adjacency graph. Arcs shown in FIG. 12 are attached with codes indicating parameters in a recognition model. The axis direction graph shown in FIG. 12 is one in the k direction, which starts from the bottom K0 and goes to the face K1 through the face K2 in the recognition model shown in FIG. 11. As can be understood by comparing FIGS. 11 and 12, arcs exist from the face K0 in the Zₐ and Z_{d} directions, and reach the face K1 from the face K2 through the arc Z_{b}. At the same time, arcs reach the face K1 by going in the Z_{c} direction from the face K2, so that the axis direction graph shown in FIG. 12 can be generated.

That is, if the above-described inconsistency occurs in axis direction graph, there is a circulation relation among elements of axis direction graph (hereafter, simply referred as “cycle” in this invention). For formulation of axis direction graph, various methods can be adopted, however, formulation of the axis direction graph shown in FIG. 12, which is intuitively easy to explain, can be performed with vector expression in the following formula (3).

[Expression 3]
(K0, zₐ, z_{b}, K2, z_{b}, z_{c}, K1) (3)

In the above formula (3), existence of the cycle of Z_{b} and Z_{c} between K2 and K1 can be judged by checking whether or not any minus element exits between Kₘ and Kₙ, which are adjoined face identifiers, in a data set of axis direction graph. In addition, besides this, loop edge is also one form of cycles. FIG. 13 shows an embodiment of axis direction graph, in which a loop edge, both ends of which are the same node so as to start from the node K and return to the node K, exists. If the cycle in FIG. 12 is structured, the same data expression can be used between the node K2 and the node K1. The following formula (4) is a vector expression of axis direction graph if the cycle between the node K2 and the node K1 shown in FIG. 12 and the loop edge shown in FIG. 13 exist.

[Expression 4]
(K2, z_{b}, K1, z_{c}, K2): the case of FIG. 12
(K, zₓ, K): the case of FIG. 13 (4)

In FIGS. 11 to 13, explanation is described using the specific and intuitively understandable embodiments. FIG. 14 shows a more general procedure of generating axis direction graph. FIG. 14(a) shows a structure of a real model, and FIG. 14(b) shows an embodiment of corresponding adjacency graph. From the real model shown in FIG. 14(a), the adjacency graph data corresponding to FIG. 14(b) is generated by the above-described method using a pair relation to be registered. Furthermore, in this invention, the data corresponding to FIG. 14(b) is read out, and then the following processing is executed to generate a data structure so as to be described in the formulas (3) and (4).

An actual generation procedure of axis direction graph will be described below.

(1) one direction of i, j, k is selected (it is assumed that k is selected, however, the other two also are same), and all nodes (clusters) in the k direction are extracted from adjacency graph to be temporarily stored in a buffer memory as nodes of axis direction graph, such as K0, K1 and K2.

(2) For an arc that connects nodes, the colors of which are neither “unknown” nor k, in adjacency graph, a corresponding cluster edge is searched. The cluster edge corresponds to a geometrical edge, with which a cluster of a different color in an original real model contacts, and is shown with an arrow in FIG. 14(b). For the all of the above-described cluster edges, the following processing can be executed. (2-1) For data corresponding to adjacency graph, nodes are identified. Two identified nodes, e.g., k0 and k1, are extracted, and cluster edges are identified during it. As the same time, direction identification data, which can specify correspondence with nodes, such as L_{i,j}, is inserted, and a data structure shown in the following formula (5) is generated between nodes.

[Expression 5]
(k₁, L_{1,2}, k₂, k₃, L_{3,4}, k₄, k₅, L_{5,6}, k₆, . . . , k₁₋₁, L₁₋₁, k₁) (5)

The above-described direction identification data L_{i,j} is shown with a short arrow intersecting with an arc in FIG. 14. Since both faces of an arc in adjacency graph correspond to both ends of a cluster edge, if direction (positive or negative) in the k direction for a cluster edge is determined, data is arranged so as to be put in increasing order of coordinates. For example, such a data structure can be generated by sequentially storing data so that the left of the parameter L_{i,j} is a node having small coordinates and the right is a node having large coordinates in the above formula (5).

At this point, if positive/negative of the k axis direction is “unknown”, a problem occurs. In this case, by not inserting the direction identification data L_{i,j}, processing corresponding to not attaching with the arrow in FIG. 14 is executed not to perform useless processing.

(2-2) For a node pair corresponding to a face in the k direction that leads to both ends of a cluster edge, vector expression data to give axis direction graph is generated to be stored in memory. In this processing, a starting node and a terminal node of axis direction graph are selected, and then direction identification data L_{i,j} near the starting node is selected. Subsequently, a next node is selected, and then next direction identification data L_{i,j} is selected. The nodes and data are sequentially registered into a buffer memory and the vector expression data is generated. This processing can be traced in FIG. 14, and the vector expression data is generated so that it starts from the node K1 and reaches the node K2 via cluster edges shown with codes “a” and “b”. The expression corresponding to the formula (3) or (4), will be provided with the following formula (6) if the parameter L_{i,j} for the codes “a” and “b” is replaced with Lₐ and L_{b} respectively.

[Expression 6]
(k1, Lₐ, L_{b}, K2) (6)

So as to be easily judged if comparing the above formula (6) with the formulas (3) and (4), the arc zₐ of axis direction graph is specified by the direction identification data L_{i,j}, and the codes in the direction identification data L_{i,j} can be used to judge the cycle. In addition, axis direction graph data can be introduced from the above-described processing of adjacency graph.

An axis direction graph in the k direction generated using the real model in FIG. 11 with the above-describe procedure is shown in FIG. 15. As shown in FIG. 15, in the axis direction graph, eight arcs in the k direction can be generated as indicated with the thick arrow. These are eight edges in the k direction in the recognition model shown in FIG. 11.

The judgment of global inconsistency using the above-described axis direction graph can be applied for ongoing clustering. That is, if nodes, the colors of which are not determined, remain in adjacency graph but processing is performed only for nodes that “color” information specified with i, j and k is registered, the existence of inconsistency within the determined range is judged.

F. <Sufficiency Method of Global Consistency>

It has been indicated that the cycle in an axis direction graph is judged using the data structure explained above. Topology operations to satisfy global consistency solve a cycle or a loop that is formed with one or a plurality of nodes, and correspond to operations that provide consistency of a real model. As a simple topological method, the topology operations can be introduced as the inverse of an arc direction in a cycle or a loop, or node splitting (cluster splitting). However, the inverse of arcs may greatly change geometrical consistency in an original recognition model. Thereby, the method to inverse arc direction may be used in this invention, however, it cannot generally be used considering geometrical meaning. Therefore, in the preferred embodiments of this invention, as processing to satisfy global topology consistency, the processing that satisfies global topology consistency using node splitting is performed.

In this invention, various splitting methods can be used to solve cycles or loops by node splitting. The number of selection methods of nodes to be splitted is the number of nodes, and for splitting methods for a particular node (cluster), there may be a plurality of methods. In this invention, it is an object to be able to perform geometrical selections by providing all possible topological solutions, so that it is preferable to use an appropriate method with as few restrictions as possible.

Generally, splitting an n-gon into two corresponds to splitting n vertexes, which constitute the n-gon, (that is, n edges to connect) into two groups (splitting, in which a vertex of a polygon is splitted, is excluded). That is, two edges are selected from n ones that constitute faces, and then they are splitted so as to be intersected. Therefore, the number of selections is at most nC₂. In the purpose of this invention, selection methods of two edges of a polygon to be splitted have the following restrictions: the two edges have the same direction among three directions of i, j and k; and one edge has the positive direction for an axis and the other has the negative one considering the direction when turning around the perimeter of a cluster in fixed direction. Under the above-described restrictions, two edges to be permitted are only some of ₙC₂ kinds.

FIG. 16 shows a splitting method to be permitted (a) and a splitting method not to be permitted (b). The splitting conditions to be permitted shown in FIG. 16(a) can be expressed that a cluster edge is splitted with intersecting the opposite edge related to either of the specified axes i, j and k when turning around the perimeter of the cluster. The specific splitting processing using a computer apparatus is executed in an adjacency graph area, generates a node pair at an appropriate position of a pair of cluster edges that are permitted with splitting, and inserts a new parameter that indicates a cluster edge between the node pair.

FIG. 17 is a figure to explain general patterns of node splitting using the embodiment shown in FIG. 11. FIG. 17 (a) shows an axis direction graph, and FIG. 17(b) shows an outline shape in a real model that provides the axis direction graph. In FIG. 17, eight arcs (a-h) of the axis direction graph and edges in the real model are shown using the same codes so that the arcs correspond to the edges. In the embodiment shown in FIG. 17, as shown in FIG. 17(a), a cycle is constituted of two node clusters K1 and K2. Hereafter, processing in the case that K2 is splitted will be explained.

To solve the left cycle (between K1 and K2) of the axis direction graph in FIG. 17(a) by cluster splitting, four arcs (a, b, c and d) connected to K2 are splitted into (a, b) and (c, d), and then they are connected to different nodes. It is because a and b go into K2 and c and d go out from K2, so that splitting methods rather than this cannot solve the cycle even if two nodes, which split K2, are connected in any direction.

From the above-described point, one of edges intersected when splitting a cluster as shown in FIG. 17, must be one shared by K2 and J1. This edge corresponds to the arc indicated with the dashed line connecting K2 and J1 of adjacency graph. From the above-described conditions, another edge to be intersected is either the arc (K2, J1) or the arc (K2, J2). Topologically, both are equally possible. In FIG. 18, the arc (K2, J2) is selected, and the node K2 is splitted into K2′, K2″ and Ix. K2 is splitted into K2′ and K2″, and at the same time, a new node Ix is inserted. In addition, an arc between K2′ and K2″ is provided with directions d1 and d2, which cannot generate a cycle. If it is geometrically inappropriate to provide such directions, this node splitting will be eliminated in the following examination. FIG. 18(b) shows an embodiment of surface clusters generated by the splitting shown in FIG. 18 (a).

The nodes influenced by this pattern are J1, J2, K2′ and K2″. The number of arcs of adjacency graph connected to each of the nodes increases by two. Since the number of arcs does not decrease, theses nodes do not break the condition (a-2). The newly generated node Ix also satisfies the condition (a-2). In addition, three new triangles are generated in the adjacency graph shown in FIG. 18(a), and satisfy the condition (a-1) by providing nodes of three different colors. That is, by applying this splitting pattern, the local conditions (a-1) and (a-2) are not broken.

In addition, the global conditions (b) are satisfied by this splitting in the k axis direction. For other axis directions, the new node Ix is inserted, so that the global conditions (b) must be judged in the following examination for condition check.

The splitting method shown in FIG. 18 is the most appropriate if a human judges considering geometry. However, the purpose of this invention is to list recognition models permitted topologically to perform geometrical selection. Thereby, not only the above-described solution, as shown in FIG. 19, a topological solution in the case that arcs (K2, J1) and (K2, J0) in the adjacency graph are selected is also outputted similarly. In addition, a solution for K1 division can be outputted similarly.

FIG. 20 shows a rough function block diagram of the shape generation apparatus 10 of this invention. The shape generation apparatus 10 of this invention has a computer apparatus 12 that includes CPU, memory and a mass storage device, such as a hard disk. In the shape generation method of this invention, the CPU reads programs described with a computer executable language, such as C++ or C language, or JAVA® (registered trademark), and controls the CPU itself of the computer apparatus 12, the memory, the hard disk device and a display device. In additions, the CPU also stores shapes generated by this invention into a recording medium, such as a hard disk, an optical magnetic disk, CD-ROM, DVD-ROM or DVD-RAM, and displays them on a display device.

With reference to FIG. 20, the shape generation apparatus 10 of this invention is constituted of the computer apparatus 12, an input device 14, such as a keyboard and a mouse, and a display device 16 including a display screen. In addition, the computer apparatus 12 is connected a network 18, such as the Internet, LAN or WAN, via a network interface (not shown), and acquires necessary data from other computer apparatuses under a network environment.

In addition, the computer apparatus 12 is connected with an input model storage part 20, an adjacency graph data storage part 22 and an axis direction graph storage part 24, and provides each data to the computer apparatus 12 if required. On the screen of the display device 16, real model data provided by topological operations immediately performed is displayed and the state of topology operations is displayed to a user.

FIG. 21 shows a detailed function block diagram of the computer apparatus 12. The computer apparatus 12 shown in FIG. 21 reads out coordinates of an input model to be generated a recognition model, generates initial clusters in a cluster data generation part 26, and calculates coordinates of cluster edges and vertices using the generated cluster values. The calculated coordinates of cluster edges and vertexes are once stored into appropriate memory 32 with identifiers to identify clusters as cluster data. The cluster coupling part 28 reads out the cluster data stored in the memory 32 and determines “color” of the clusters. In addition, the cluster coupling part 28 executes cluster coupling processing and updates in accordance with the coupling degree of the cluster data to store it into the memory 32 again as cluster data.

The topology judgment part 30 reads the updated cluster data from the memory 32, and calculates adjacency graph using a pair relation to store the adjacency graph data into an adjacency graph storage part 22 that is constituted of a hard disk or other devices. Furthermore, the topology judgment part 30 reads the adjacency graph data from the adjacency graph storage part 22, and executes judgment of the local and global consistency conditions to transmit the result to a topology operation part 34. The topology operation part 34 processes the adjacency graph data so as to satisfy the local conditions, and then transmits the processed adjacency graph data to the topology judgment part 32 again to execute judgment of the global consistency conditions.

In the judgment of the global consistency conditions, the topology judgment part 30 includes an axis direction graph data generation part 30a to generate an axis direction graph from the received adjacency graph data, and allows the axis direction graph data storage part 22 to store the axis direction graph data. The topology judgment part 30 judges the global consistency conditions using the axis direction graph data, and if the global consistency conditions are not satisfied, allows the topology operation part 34 to read the corresponding adjacency graph data and to perform splitting processing for the adjacency graph data so as to satisfy the global consistency conditions. The splitting processed adjacency graph data is stored into the adjacency graph data storage part 22, and its data is updated. Then, the cluster coupling part 28 reads out the updated adjacency graph data, and generates cluster data that satisfies the local and global consistency conditions. Subsequently, the cluster coupling part 28 transmits the cluster data improved with consistency conditions to the cluster coupling processing part again to execute processing.

FIG. 22 shows the outline of results of the topology judgment processing and the topology operation processing in this invention. The processing of this invention generates a plurality of solutions provided with topological consistency as a recognition model. This is resulted from that a plurality of operations can be applied if the topology operations to satisfy consistency conditions (local operations to be described below and the global “node splitting” operations) are applied. If there is a plurality of improvement methods for one inconsistent state (clustering), independent, different states that are applied with each method are generated. Therefore, as shown in FIG. 22, the states are developed in the shape of a tree, and at a point (the node shown with hatching), at which topological inconsistency is eliminated, the branch is stopped.

All of the topology operations performed in this process act in a direction, in which inconsistency is eliminated, so that the tree dose not become large infinitely. In addition, the length of a branch indicates the number of added topology operations, so that the length of a branch can be restricted to avoid clustering that is too much different from its original shape topologically. In either way, since inconsistency that occurs in real problems is small, trees do not become too large.

FIG. 23 shows shapes generated for every generating stage of a recognition model according to the method of this invention.

An input model used for processing has global inconsistency and is the same as the input model shown in FIG. 24. To eliminate global inconsistency according to the method of this invention, the faces are splitted, so that splitting into a good structure mesh is possible.

A set of clustering having consistency generated by the processing of this invention includes all clusterings that can be generated with a series of topology operations. Therefore, the most geometrically appropriate clustering (that can structure a recognition model of the high degree of approximation) can be selected from them through graphical interface in a computer apparatus.

[Advantages of the Invention]

The conventional method, in which triangle (and quadrilateral) elements that constitute the faces of a shape model are splitted into clusters to construct the topology of a recognition model, has a problem that consistency cannot be guaranteed and mesh generation processing is not progressed. In this invention, a topology structure of clustering is structured with two graphs, such as adjacency graph and axis direction graph, and conditions are judged using attributes provided to nodes and arcs to judge local and global consistency and to locate its cause.

Furthermore, there is indicated the method to mechanically acquire topology structures that satisfy consistency conditions by applying a series of operations on adjacency graph for both local and global inconsistencies. Using these methods, there can be provided with a plurality of candidate solutions for a recognition model guaranteed with topology consistency. Thereby, without troubles on topology problems, a user can acquire one solution considering only geometrical criteria, and if automation of geometrically narrowing down to one solution is realized, automation of whole processing can be expected.

The proposed judgment and correction operations can also be applied during clustering. By applying these operations in an early stage of processing, the possibility to reach more desirable clustering can be raised.

<Bibliography>

Hiroaki Takahashi et. al, “Development of 3-dimensional Automatic Element Splitting System using Shape Recognition”, Transactions of the Japan Society of Mechanical Engineers, Vol. 59, No. 569, pp. 279-285, 1993.
Reza Taghavi, “Automatic Block Decomposition Using Fuzzy Logic Analysis”, 9th International Meshing Roundtable, pp. 187-192, 2000.
David R. White, et. al, Automated Hexahedral Mesh Generation by Virtual Decomposition, 4th International Meshing Roundtable, 1995.
Jun Doi et. al, “Recognition Model Constructing Method—Topology Generation by Clustering, Graphics and CAD Symposium.
Atsushi Yamada et. al, “Recognition Model Constructing Method without Self Interference for Hexahedron Mesh Generation”, The Japan Society for Industrial and Applied Mathematics 2002, 2002.

### BRIEF DESCRIPTION OF THE DRAWINGS

FIG. 1 shows one part of a cluster used in this invention (a) and an adjacency graph for the part (b);

FIG. 2 shows a rough method to determine concave and convex of the form constituted of surface clusters f₁ and f₂, and an edge L;

FIG. 3 shows the concave and convex relations acquired from the shape shown in FIG. 2;

FIG. 4 shows a rough flowchart of processing of the shape generation method of this invention;

FIG. 5 shows conditions to judge local conditions at step S28 in the shape generation method of this invention, which is restrictedly indicated using a real model;

FIG. 6 shows a detailed flowchart of topology examination and operation processing in this invention;

FIG. 7 shows the outline of processing of arranging the clusters listed in FIG. 3 around a vertex using data replaced into patterns in adjacency graph;

FIG. 8 shows the outline of processing of topology operations 1 and 2;

FIG. 9 shows a rough processing procedure of topology operations 3 using a real model;

FIG. 10 shows a real model example including topology in consistency;

FIG. 11 shows an embodiment in the case of specific inconveniency that occurs in a real model having global inconsistency;

FIG. 12 shows an embodiment of axis direction graph in the k direction (vertical direction) of the recognition model shown in FIG. 11;

FIG. 13 shows an embodiment of axis direction graph, in which an edge, both ends of which are the same, exists;

FIG. 14 shows a conventional procedure generating an axis direction graph;

FIG. 15 shows the axis direction graph in the k direction, which is generated using the real model in FIG. 11;

FIG. 16 shows a splitting method to be permitted (a) and a splitting method not to be permitted (b);

FIG. 17 explains general patterns of node splitting using the embodiment shown in FIG. 11;

FIG. 18 shows the state, in which arcs (K2, J2) are selected and then a node K2 is splitted into K2′, K2″ and Ix;

FIG. 19 shows another embodiment of an output result of this invention;

FIG. 20 shows a rough function block diagram of the shape generation apparatus of this invention;

FIG. 21 shows a detailed function block diagram of a computer apparatus 12;

FIG. 22 shows the outline of results of topology judgment processing and topology operation processing in this invention;

FIG. 23 shows forms generated at each generation stage of a recognition model according to the method of this invention;

FIG. 24 shows a specific example, in which a consistent recognition model cannot be generated with a conventional method.

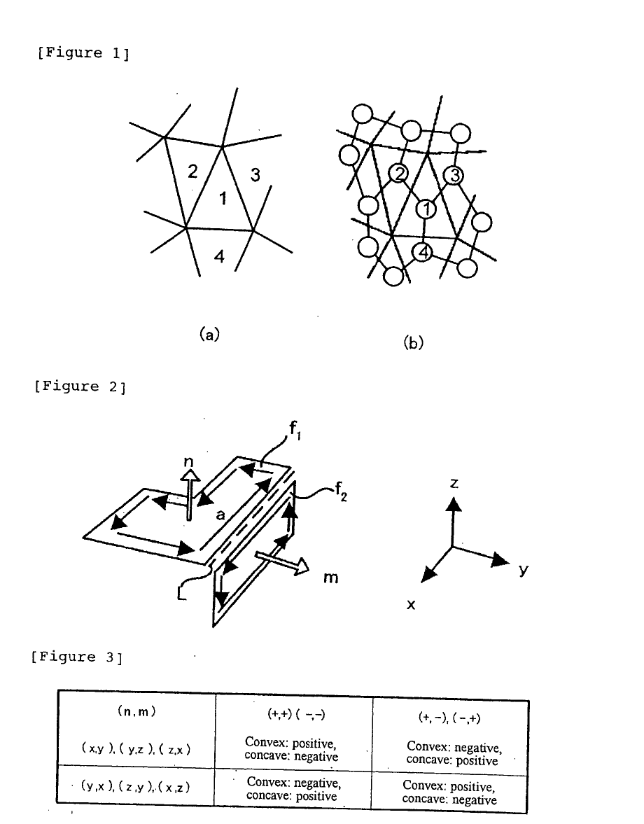

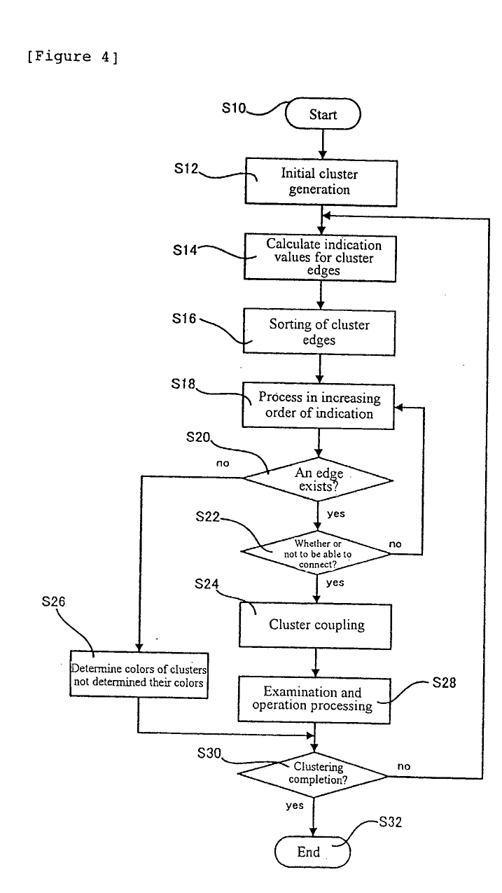

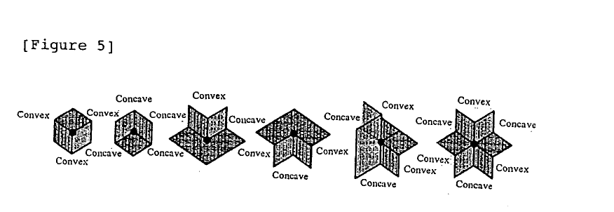

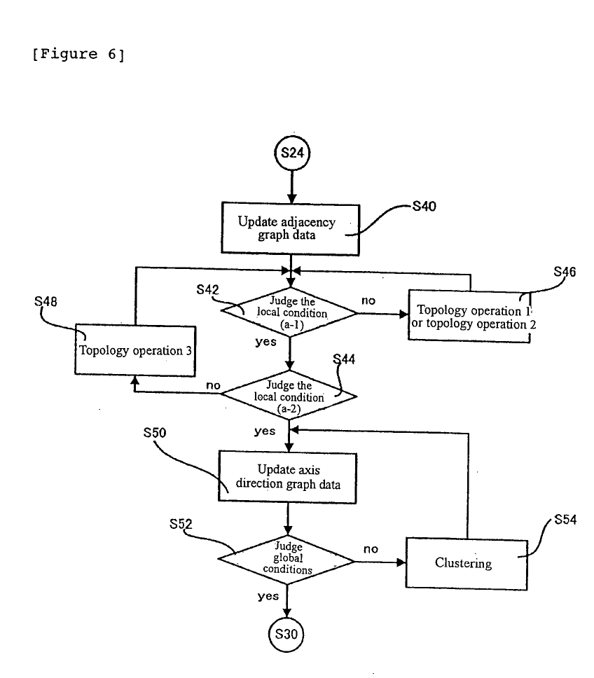

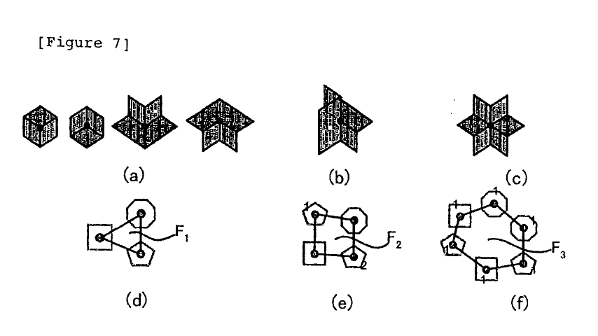

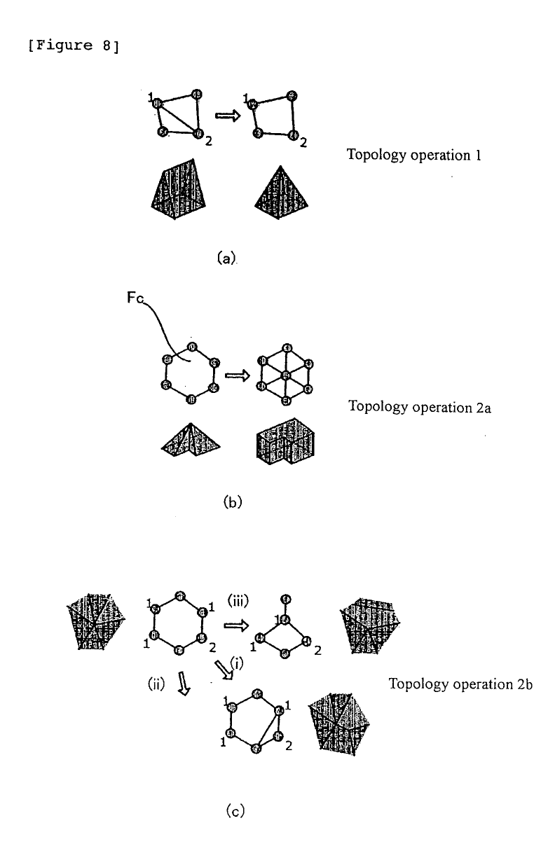

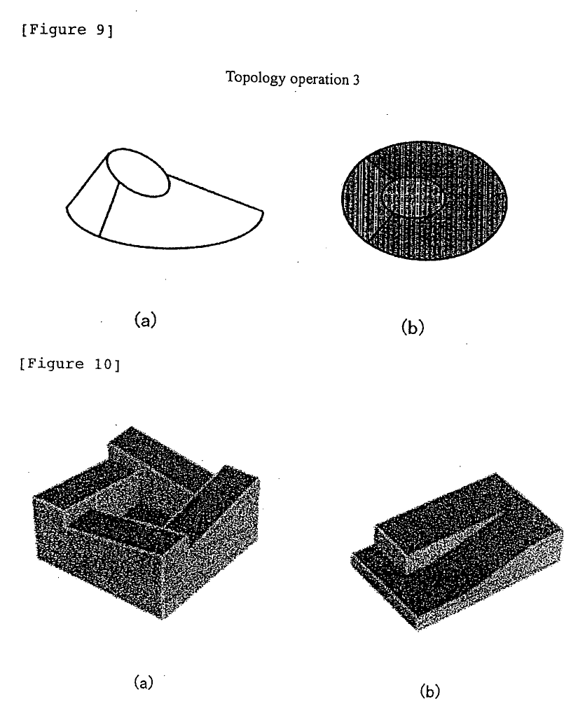

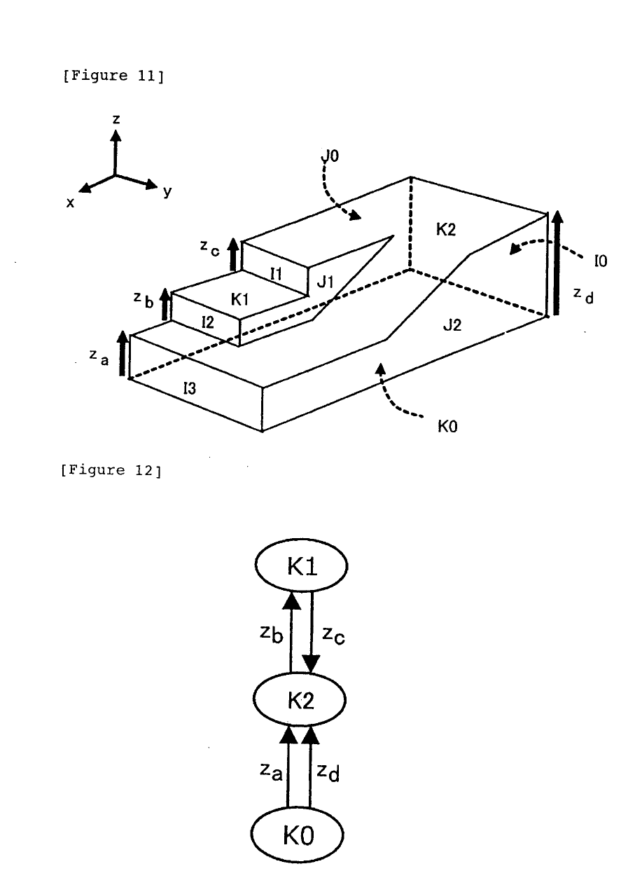

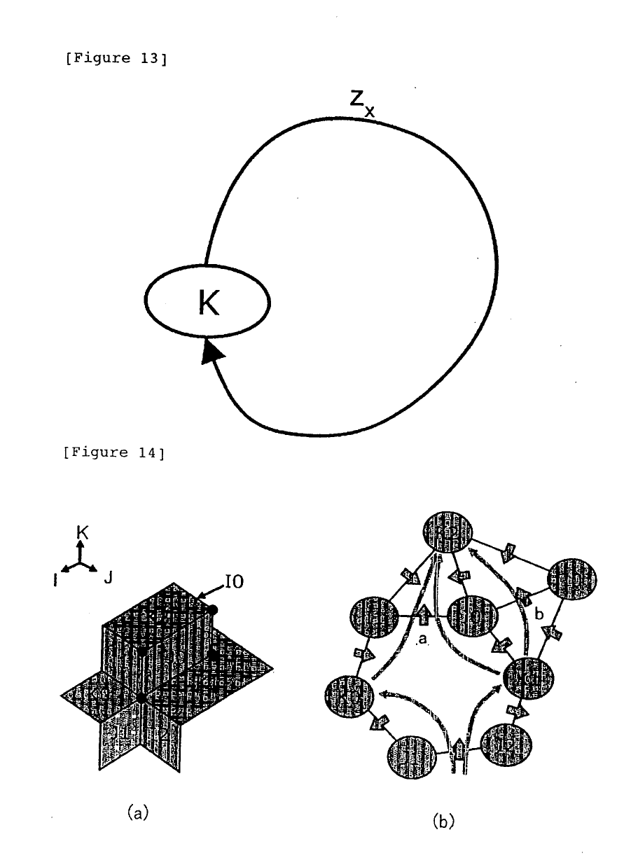

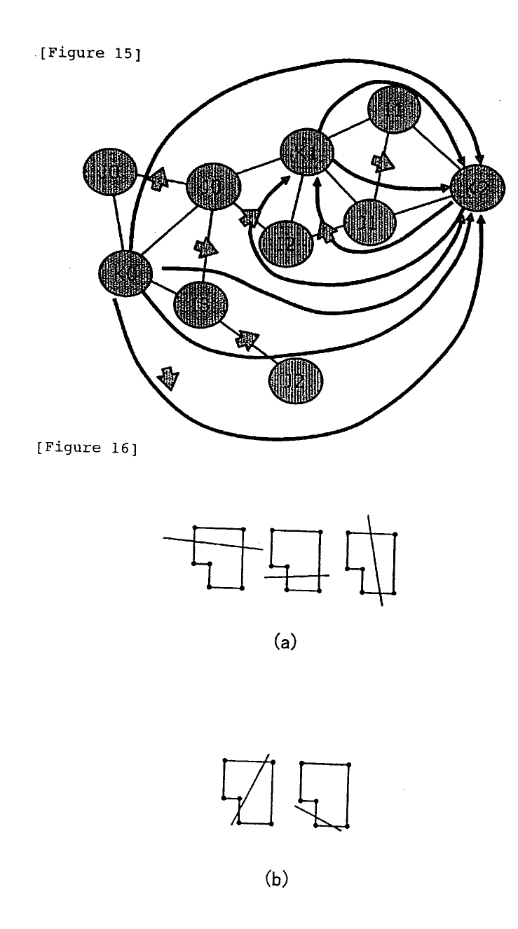

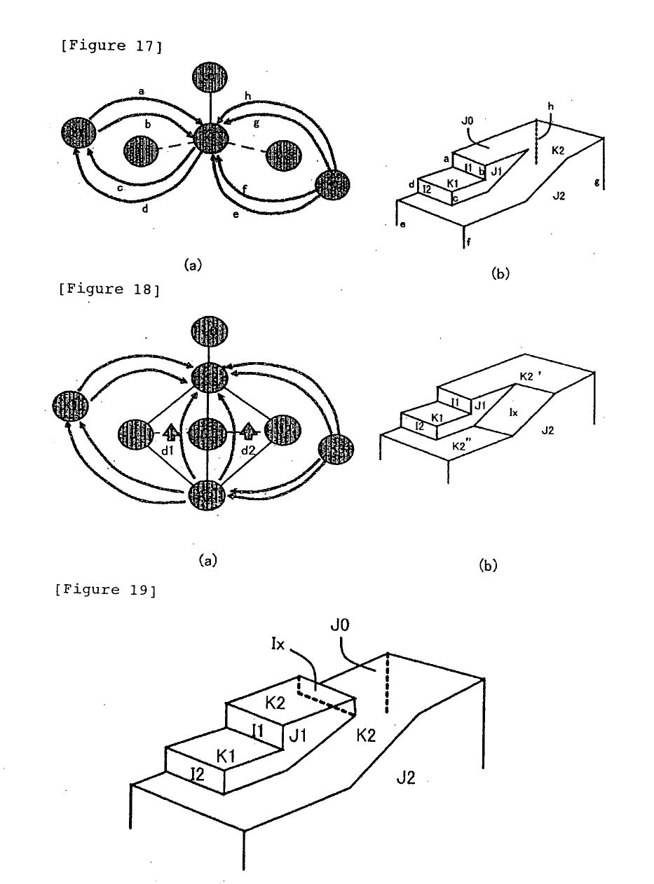

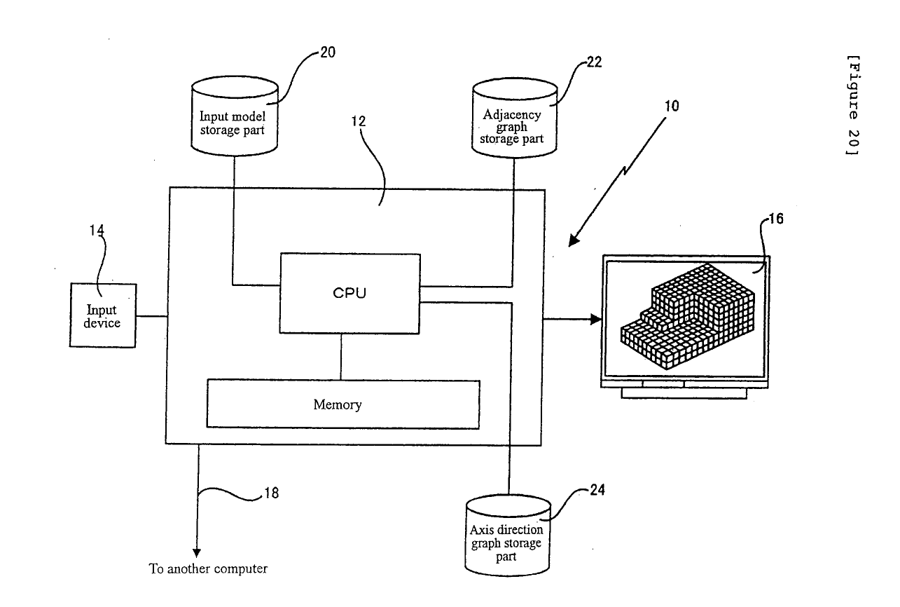

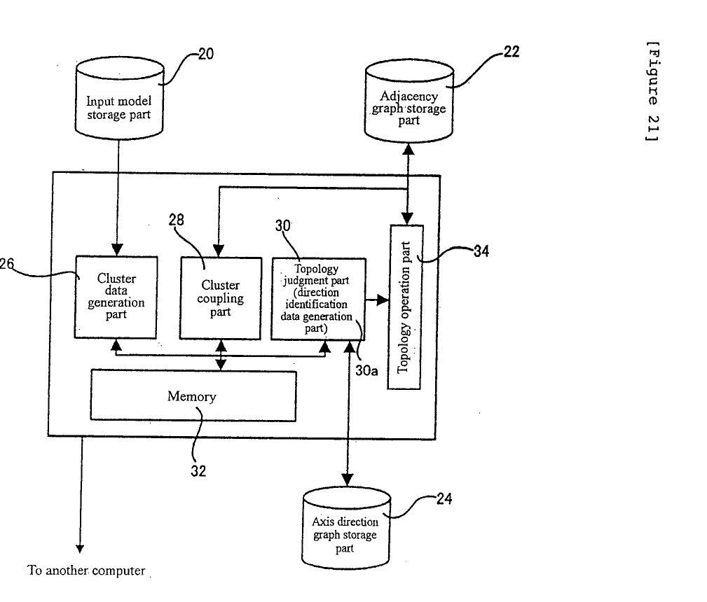

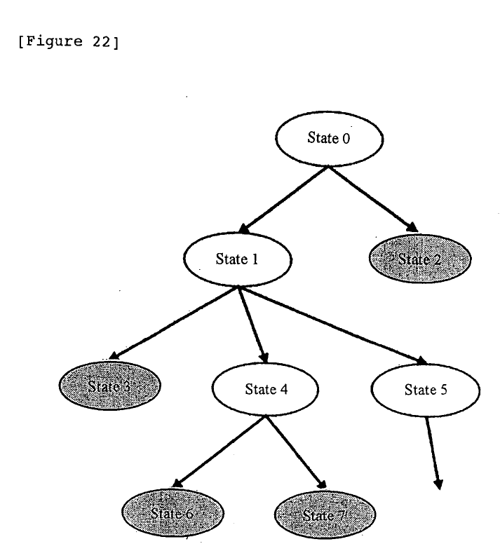

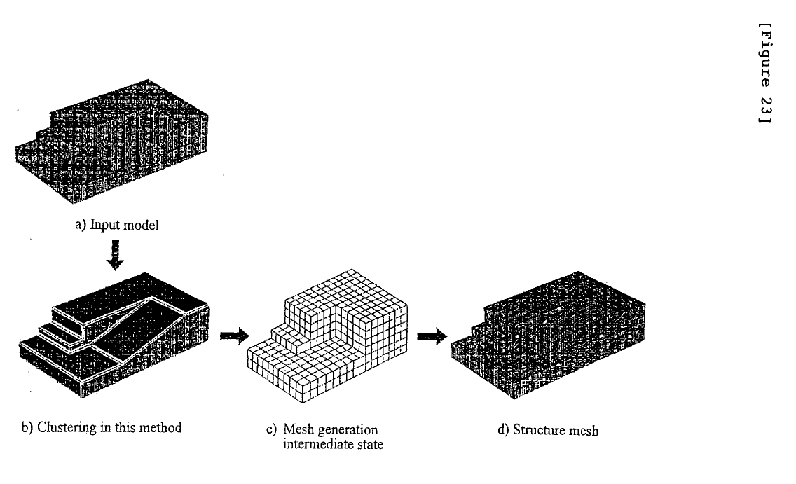

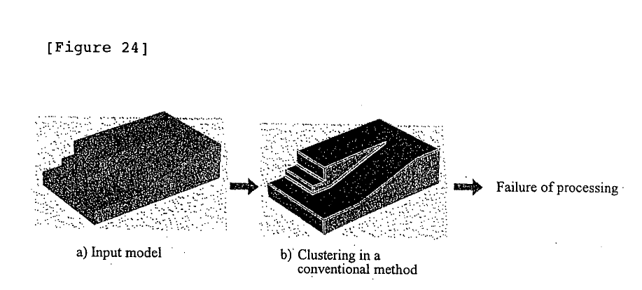

### DESCRIPTION OF SYMBOLS

10 . . . Shape generation apparatus
12 . . . Computer apparatus
14 . . . Input device
16 . . . Display device
18 . . . Network
20 . . . Input model storage part
22 . . . Adjacency graph storage part
24 . . . Axis direction graph storage part
26 . . . Cluster data generation part
28 . . . Cluster coupling part
30 . . . Topology judgment part
32 . . . Memory
34 . . . Topology operation part

1. A shape generation apparatus for 3-dimensional objects using a computer apparatus, comprising:
an input model storage part to store 3-dimensional input model data;
an adjacency graph storage part to scre adjacency graph data generated by assigning surface clusters to the input model data;
a cluster coupling part which executes coupling processing of surface clusters of the adjacency graph data;
a topology judgment part which reads out the adjacency graph data and judges topology of the read adjacency graph data; and
a topology operation part which responds to judgment of the topology judgment part and changes node data or arc data of adjacency graph data.

2. The shape generation apparatus according to claim 1, wherein
the topology judgment part reads put the adjacency graph data, judges topology of arcs and nodes of the adjacency graph data, and allows the topology operation part to acquire corresponding adjacency graph data in response to the judgment.

3. The shape generation apparatus according to claim 2, wherein
another node and indicates the crossing direction of the arc, and an axis direction graph data generation part, which generates axis direction graph data that corresponds the specified node to the other, and the shape generation apparatus includes an axis direction graph storage part to store generated axis direction graph data.

4. The shape generation apparatus according to claim 3, wherein
the topology judgment part reads out axis direction graph data from the axis direction graph storage part, judges the existence of cycle or loop between the nodes using the direction identification data, and allows the topology operation part to acquire corresponding adjacency graph data in response to the judgment.

5. The shape generation apparatus according to claim 1, wherein
the topology operation part changes node data or arc data of the acquired adjacency graph data with reference to a topology table, and updates data in the adjacency graph data storage part using the changed adjacency graph data.

6. The shape generation apparatus according to claim 5, wherein
the cluster coupling part judges update of the adjacency graph data and acquires the updated adjacency graph data.

7. A control method to control a computer apparatus as a shape generation apparatus for 3-dimensional objects allows the computer apparatus to execute:
a step of storing 3-dimensional input model data into an input model storage part;
a step of storing adjacency graph data, which is generated by assigning surface clusters to the input model data, into an adjacency graph data storage part;
a step of allowing a cluster coupling part to read the adjacency graph data, perform coupling processing of surface clusters, and store the processing result into memory;
a step of allowing a topology judgment part to read out adjacency graph data stored in the memory and judge the topology of adjacency graph data; and
a step of allowing a topology operation part to read adjacency graph data in response to judgment of the topology judgment part.

8. The method according to claim 7 allows the computer apparatus to execute:
a step of allowing the topology judgment part to read out the adjacency graph data and judge the topology of arc and node of the adjacency graph data; and
a step of allowing the topology operation part to acquire corresponding adjacency graph data in response to the judgment.

9. The method according to claim 8, wherein
the topology judgment part includes an axis direction graph data generation part, and the control method allows the axis direction graph data generation part to execute:
a step of identifying an arc that crosses from a specified node of the adjacency graph data to another one and calculating direction identification data to indicate crossing direction of the arc; and
a step of generating axis direction graph data, which is associated with the direction identification data, the specified node and the other, and registered, and allowing the axis direction graph storage part to store the generated graph data.

10. The method according to claim 9 allows the topology judgment part to execute:
a step of reading out axis direction graph data from the axis direction graph storage part and judging the existence of cycle or loop between the nodes using the direction identification data; and
a step of allowing the topology operation part to acquire corresponding adjacency graph data in response to the judgment.

11. The method according to claim 10 allows the topology operation part to execute:
a step of changing node data or arc data of the acquired adjacency graph data based on topology information to change adjacency graph data; and
a step of updating data in the adjacency graph data storage part using the changed adjacency graph data.

12. The method according to claim 11 allows the cluster coupling part to execute:
a step of judging update of the adjacency graph data and acquiring the updated adjacency graph data.

13. Computer executable programs, which allow a computer apparatus to execute a control method of shape generation for 3-dimensional objects, the computer executable programs comprising the steps of:
storing 3-dimensional input model data into an input model storage part;
storing adjacency graph data which is generated by assigning surface clusters to the input model data, into an adjacency graph data storage part;
allowing a cluster coupling part to read the adjacency graph data, perform coupling processing of surface clusters, and store the processing result into memory;
allowing a topology judgment part to read out adjacency graph data stored in the memory and judge the topology of adjacency graph data; and
allowing a topology operation part to read adjacency graph data in response to judgment of the topology judgment part.

14. The computer executable programs according to claim 13, the computer executable programs further including the steps of:
allowing the topology judgment part to read out the adjacency graph data and judge the topology of arc and node of the adjacency graph data; and
allowing the topology operation part to acquire corresponding adjacency graph data in response to the judgment.

15. The computer executable programs according to claim 14, wherein
the topology judgment part includes an axis direction graph data generation part, and the axis direction graph data generation part comprises the steps of:
identifying an arc that crosses from a specified node of the adjacency graph data to another one and calculating direction identification data to indicate crossing direction of the arc; and
generating axis direction graph data, which is associated with the direction identification data, the specified node and the other, and registered, and allowing the axis direction graph storage part to store the generated graph data.

16. The computer executable programs according to claim 15, wherein the topology judgment part comprises the steps of:
reading out axis direction graph data from the axis direction graph storage part and judging the existence of cycle or loop between the nodes using the direction identification data; and
allowing the topology operation part to acquire corresponding adjacency graph data in response to the judgment.

17. The computer executable programs according to claim 16, wherein the topology operation part comprises the steps of:
changing node data or arc data of the acquired adjacency graph data based on topology information to change adjacency graph data; and
updating data in the adjacency graph data storage part using the changed adjacency graph data.

18. The computer executable programs according to claim 17, wherein the cluster coupling part comprises the step of:
judging update of the adjacency graph data and acquiring the updated adjacency graph data.
